(19) United States
(12) Patent Application Publication
(10) Pub. No.: US 2004/0078603 A1
(43) Pub. Date: Apr. 22, 2004

(54) System and method of protecting data

(76) Inventors: Eiji Ogura, Sunnyvale, CA (US); Yoshihiro Tsukamura, Cresskill, NJ (US); Hiroyuki Yasuda, Englewood, NJ (US)

Correspondence Address: Valley Oak Law, 5655 Silver Creek Valley Road, #106, San Jose, CA, 95138, US

(21) Appl. No.: 10/273,662

(22) Filed: Oct. 18, 2002

(51) Int. Cl. H04L 9/32

(52) U.S. Cl. 713/202

(57) ABSTRACT

A system and method for protecting confidential data within an electronic device are described. The invention allows the authentication of the identity of the user through the user of a primary and/or secondary authentication system. In one embodiment, the system includes a pin module for locally storing a unique user identifier configured to correspond to an identity of an individual; an answer module for locally storing an answer set wherein the answer set comprises an answer to a corresponding question and is configured to correspond to the identity of the individual; and a controller for locally authenticating the identity of the individual by comparing an input with the answer set.

### BACKGROUND OF THE INVENTION

The use of passwords is often utilized to confirm the identity of the user of a device. With the increased availability of electronic devices such as desktop computers, laptops, personal digital assistants (PDAs), and cellular phones, there has been an increased use of passwords to confirm the identity of the user.

In a password system, a password is typically initialized within the electronic device. When a user inputs the password to the password system, the password inputted by the user is compared with the initialized password. If the two passwords coincide with each other, the password system is activated and protected data is made available to the user.

Once a password is initialized within the password system, the password system typically cannot be started afterward unless the user inputs the same password as initialized. For example, if the user forgets the password after it is initialized in the system, the password system cannot be started unless the identical password as entered upon initialization is input to the system.

In the event that the initialized password is forgotten by the user or the initialized password is corrupted by the password system such that access to the electronic device is prevented to the user, re-initializing the password is typically very difficult. In order to provide a robust and reliable security mechanism, the password system is typically designed to prevent change to the initialized password without confirming the identity of the user.

In a typical password system, an initialized password is reset by sending the electronic device back to the manufacturer and having the manufacturer reset the password. In another possible scenario, the protected data within the electronic device is lost when the initialized password is reset by a user whose identity cannot be authenticated.

### SUMMARY OF THE INVENTION

A system and method for protecting confidential data within an electronic device are described. The invention allows the authentication of the identity of the user through the user of a primary and/or secondary authentication system. In one embodiment, the system includes a pin module for locally storing a unique user identifier configured to correspond to an identity of an individual; an answer module for locally storing an answer set wherein the answer set comprises an answer to a corresponding question and is configured to correspond to the identity of the individual; and a controller for locally authenticating the identity of the individual by comparing an input with the answer set.

### BRIEF DESCRIPTION OF THE DRAWINGS

The present invention is illustrated by way of example and not limitation in the figures of the accompanying drawings, in which like references indicate similar elements and in which:

FIG. 1 is a simplified block diagram of one embodiment of a password system.

FIG. 2 is a simplified block diagram of one embodiment of a local device.

FIG. 3 is a simplified block diagram of one embodiment of a remote device.

FIG. 4 is a simplified block diagram of one embodiment of a question and answer set.

FIG. 5 illustrates a flow diagram for performing an initialization transaction according to one embodiment of the system.

FIG. 6 illustrates a flow diagram for performing an access transaction according to one embodiment of the system.

FIG. 7 illustrates a flow diagram for performing an access transaction according to one embodiment of the system.

FIG. 8 illustrates a flow diagram for performing an access transaction according to one embodiment of the system.

FIG. 9 illustrates a flow diagram for performing an access transaction according to one embodiment of the system.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

A system and method provides multiple ways to authenticate the identity of an individual within a local device. Once the identity of the individual is authenticated, the individual is given access to the protected data. The invention is configured to store the confidential authenticating data only within the local device. The invention does not require the use of a remote device or server to store the confidential authenticating data. The invention allows the individual reset or reconfigure the confidential authenticating data once the identity of the individual is confirmed.

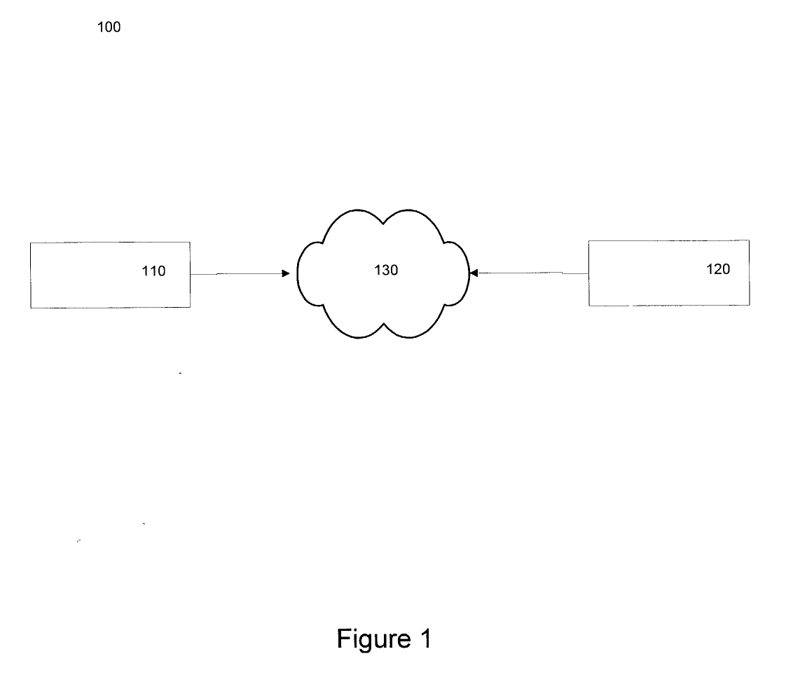

FIG. 1 is a simplified overview diagram of one embodiment of a data protection system 100. The data protection system 100 includes a local device 110, a remote device 120, and a transmission system 130.

In one embodiment, the local device 110 and the remote device 120 are configured to communicate via the transmission system 130. The transmission system 130 may include the Internet, point-to-point wiring, microwave transmission, radio frequency transmission, infrared transmission, and the like.

In one embodiment, the local device 110 is configured to allow a user to locally initialize the local device 110 with authenticating information which uniquely identifies the user. The local device 110 provides the user with access to protected data once the local device 110 receives the authenticating information which corresponds with the particular user. The local device 110 stores the authenticating information within the local device 110.

The local device 110 may utilize a variety of ways to interface with a user. The local device 110 may employ a voice recognition reader, a fingerprint reader, a keypad, an eye scan reader, and the like.

The authenticating information may include a personal identification number (PIN), a password, answers to questions, a fingerprint, an eye scan, and the like. The authenticating information may be utilized to uniquely confirm the identity of a user who submits the authenticating information. In one embodiment, the local device 110 stores the authenticating information as protected data. In another embodiment, the local device 110 stores the question information as unprotected data.

In one embodiment, the remote device 120 provides the local device 110 with unprotected data which is accessible to any user without providing the authenticating information. The remote device 120 is not configured to receive the authenticating information from the local device 110.

In one embodiment, the local device 110 and the remote device 120 are configured to occasionally communicate through the transmission system 130. In another embodiment, the local device 110 and the remote device 120 are configured to periodically communicate through the transmission system 130. In yet another embodiment, the local device 110 and the remote device 120 are configured to constantly communicate through the transmission system 130.

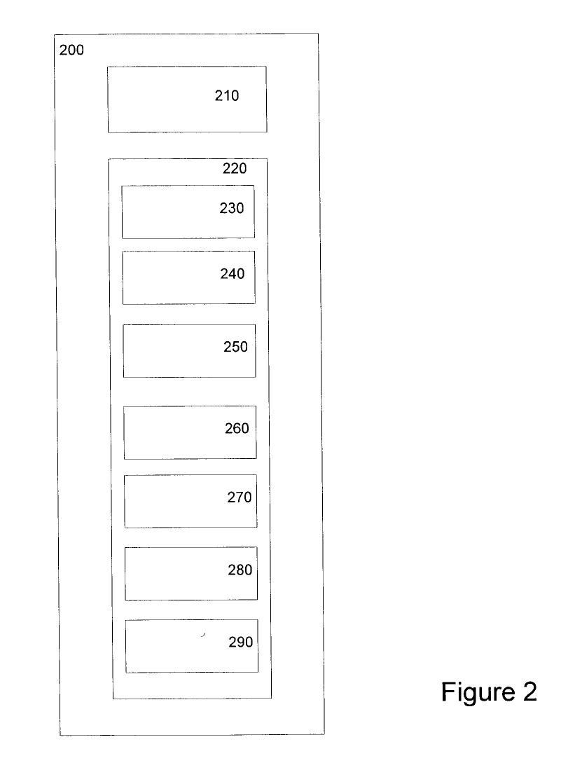

FIG. 2 is a simplified block diagram of one embodiment of a local device 200 within a security system. The local device 200 includes a controller 210 and a storage device 220. The storage device 220 includes an identification module 230, an authentication module 240, a version code module 250, a selected question module 260, an answer set module 270, a protected data storage module 280, and a non-protected data storage module 290.

The controller 210 may be implemented in hardware, software, and/or firmware. The controller 210 is configured to communicate with the storage device 220.

The identification module 230 is configured to store a unique identification which corresponds to a particular user. For example, the identification module 230 may store a first and/or last name of the user to identify the particular user. In other embodiments, the identification module 230 utilizes a different identifier to uniquely identify the user.

The authentication module 240 is configured to store the authenticating information which is utilized to uniquely confirm the identity of the user. In one embodiment, the authenticating information correlates with a particular user as identified in the identification module 230. In one embodiment, the authenticating information may include a variety of items which may confirm the identity of the user. The authenticating information may include a PIN, password, fingerprint, eye scan, DNA sample, and the like. The authentication module 240 may function as a primary authentication device.

The version code module 250 is configured to store information which identifies a particular question set that is selected by the user. In one embodiment, the user may select one question set from a plurality of question sets.

In one embodiment, the selected question module 260 is configured to store particular questions which are selected by the user from a plurality of questions within the particular question set as identified in the version code module 250. In another embodiment, the particular questions which are selected by the user from a plurality of questions within the particular question set are stored at a remote location. An identifier which represents the actual particular questions are stored within the selected question module 260.

The answer set module 270 is configured to store an answer generated by the user during an initialization process for each of the selected questions. The answer stored within the answer set module 270 may serve as a secondary authenticating information if a primary authenticating information is not available. For example, in one embodiment, the password, PIN, fingerprint, and/or iris scan comprises the primary authenticating information for a user. If either the password or PIN is forgotten or a malfunction prevents the password, PIN, fingerprint, or iris scan from being accepted, the secondary authenticating information may be utilized to authenticate the identity of the user.

The protected data storage module 280 is configured to store protected data which is made available to the user once the identity of the user is authenticated. In one embodiment, the protected data is not available until the identity of the user is authenticated.

The unprotected data storage module 290 is configured to store unprotected data which is made available to the user at any time. In another embodiment, the unprotected data may include hints for the user to provide the correct PIN and/or password. In another embodiment, the unprotected data may include non-confidential data.

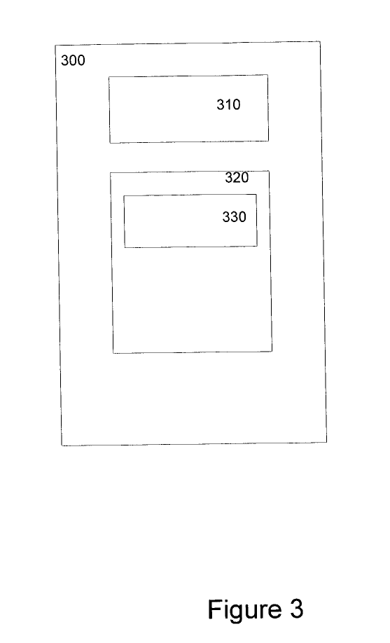

FIG. 3 is a simplified block diagram of one embodiment of a remote device 300 within a security system. The remote device 300 includes a controller 310 and a storage device 320. The controller 310 may be implemented in hardware, software, and/or firmware. The controller 210 is configured to communicate with the storage device 220.

The storage device 320 includes a question set module 330. In one embodiment, the question set module 330 includes a plurality of question sets. In one embodiment, each question set includes a plurality of questions. Each of the questions prompts the user to provide an answer which aids in providing secondary authenticating information to authenticate the identity of the user.

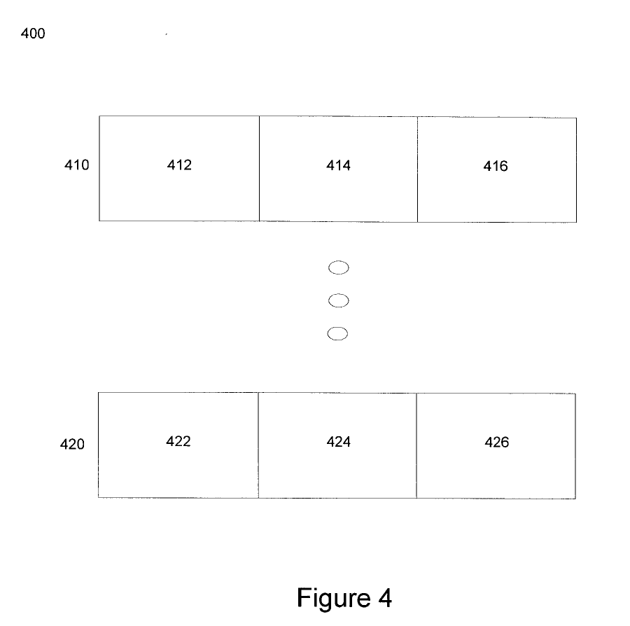

FIG. 4 illustrates one embodiment of a question set 400. In one embodiment, the question set 400 includes multiple questions. For example, the question set 400 includes M questions. Question 410 represents the first question within the question set 400. In one embodiment, the question 410 includes a field for version code 412, a question number 414, and question text 416. Question 420 represents the Mth question within the question set 400. The question 420 includes a field for version code 422, a question number 424, and question text 426.

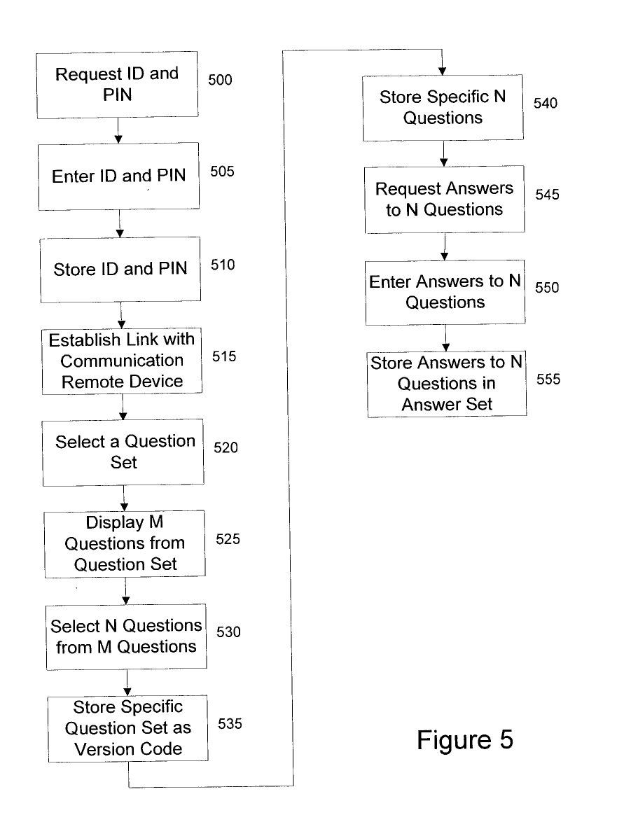

The operation of the system of FIG. 1 while a user interacts with the system 100 is described with references to the flow diagrams shown in FIGS. 5, 6, 7, 8, and 9.

The flow diagrams as depicted in FIGS. 5, 6, 7, 8, and 9 illustrate one embodiment of the invention. The blocks may be performed in a different sequence without departing from the spirit of the invention. Further, blocks may be deleted, added or combined without departing from the spirit of the invention.

FIG. 5 illustrates a flow diagram for performing an initialization transaction according to one embodiment of the invention. In Block 500, a local device requests an identification and a PIN from a user. The identification may include a name or other identifier to uniquely identify the user. The PIN is utilized to authenticate the identity of the user. In another embodiment, the local device may request a password, fingerprint, iris scan, and the like in place of the PIN.

In Block 505, the identification and PIN are entered into the local device. In Block 510, the identification is stored in the identification module 230 (FIG. 2), and the PIN is stored in the authentication module 240 (FIG. 2).

In Block 515, the local device establishes a link with a remote device. The remote device may be a server and may be linked to the local device via a transmission system.

In Block 520, the remote device selects a particular question set. In one embodiment, the selection of the particular question set may be randomly determined. In another embodiment, the selection of the particular question set may be determined in a pre-assigned order. In yet another embodiment, there may be only a single question set.

In Block 525, the particular question set as selected from the Block 520 is shown to the user. In one embodiment, the particular question set contains M questions.

In Block 530, the user selects N questions from the M questions contained within the particular question set chosen in the Block 520 and displayed in the Block 525. N is shown as a subset of M. The user may select these particular N questions for a variety of reasons.

In Block 535, a version code which corresponds to the particular question set as selected from the Block 520 is stored within the version code module 250 (FIG. 2) in one embodiment. In another embodiment, the version code is stored within the remote device.

In Block 540, the specific N questions selected by the user in the Block 530 are stored within the selected question module 260 (FIG. 2) in one embodiment. In another embodiment, a plurality of identifiers which corresponds to the specific N questions selected by the user in the Block 530 are stored within the selected question module 260. In yet another embodiment, the specific N questions selected by the user in the Block 530 are stored within the remote device.

In Block 545, the local device requests answers to the specific N questions selected by the user in the Block 530.

In Block 550, answers to the specific N questions are provided to the local device. In Block 555, these answers to the specific N questions are stored within the answer module 280 (FIG. 2).

In one embodiment, the PIN serves as the primary authenticating information to confirm the identity of the user. In addition, the answers to the specific N questions serve as a secondary authenticating information to confirm the identity of the user in one embodiment. Both the primary and secondary authenticating information is stored on the local device.

By storing both the primary and secondary authenticating information on the local device, it is not necessary to maintain a continuous connection between the local device and the remote device to authenticate the identity of the user. Further, by storing the authenticating information on the local device, the opportunities of unauthorized parties intercepting the primary or secondary authenticating information are minimized.

Further, the primary authenticating information may fail to properly authenticate the identity of the user for a variety of reasons. In this case, the secondary authenticating information is configured to authenticate the identity of the user and allow the user to modify the primary authenticating information and/or access the protected data without undue delay.

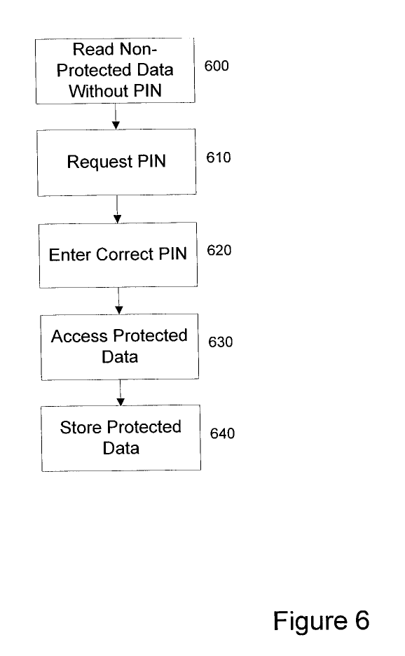

FIG. 6 illustrates a flow diagram for performing an access transaction according to one embodiment of the invention. In Block 600, the nonprotected data may be accessed at any time prior to or after entering a correct PIN. In Block 610, a PIN is requested. In Block 620, a correct PIN is entered which authenticates the identity of the user. In Block 630, the protected data may be accessed. In Block 640, additional data may be stored as a portion of the protected data.

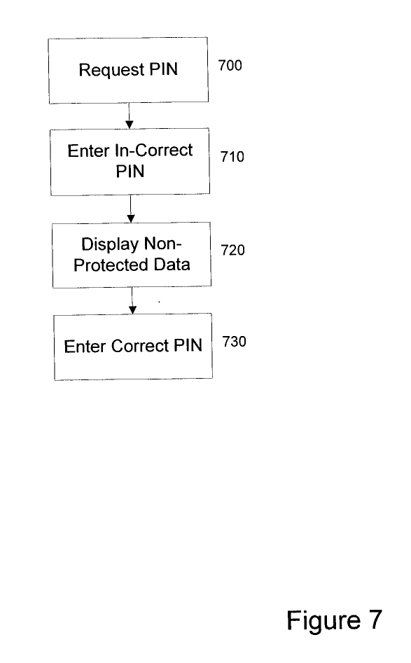

FIG. 7 illustrates a flow diagram for performing an access transaction according to one embodiment of the invention. In Block 700, a PIN is requested. In Block 710, an incorrect PIN is entered which fails to authenticate the identity of the user. In Block 720, the unprotected data may be accessed and displayed. The unprotected data may include hints or help to assist the user in successfully entering the correct PIN. In Block 730, the correct PIN is entered, thereby authenticating the identity of the user and allowing the user to access protected data.

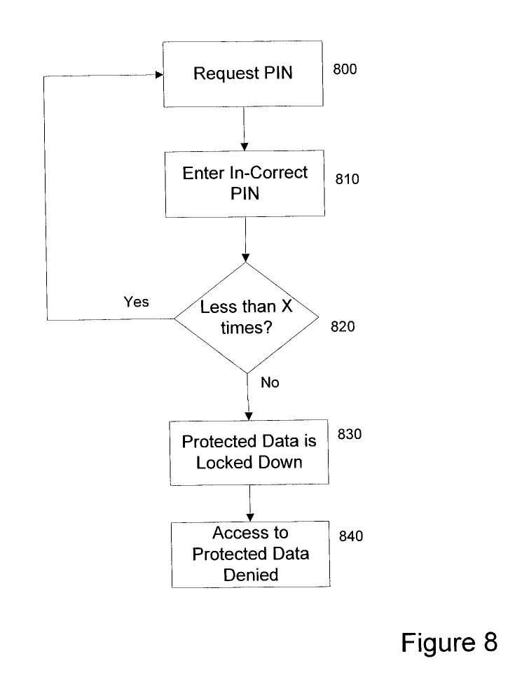

FIG. 8 illustrates a flow diagram for performing an access transaction according to one embodiment of the invention. In Block 800, a PIN is requested. In Block 810, an incorrect PIN is entered which fails to authenticate the identity of the user.

In Block 820, the number of times the incorrect PIN is supplied is counted. If the number of incorrect entries is fewer than X times, then the process returns to the Block 800, and the PIN is requested again. In one embodiment, X can be any number of times. However, if the number of incorrect entries is equal to X times, then the protected data is locked down in Block 830. Once the protected data is locked down, the protected data cannot be accessed in Block 840.

In this embodiment, the protected data is configured to be locked down after X attempts at entering the correct PIN to provide extra protection against unauthorized access through multiple entries of incorrect PINs by trial and error.

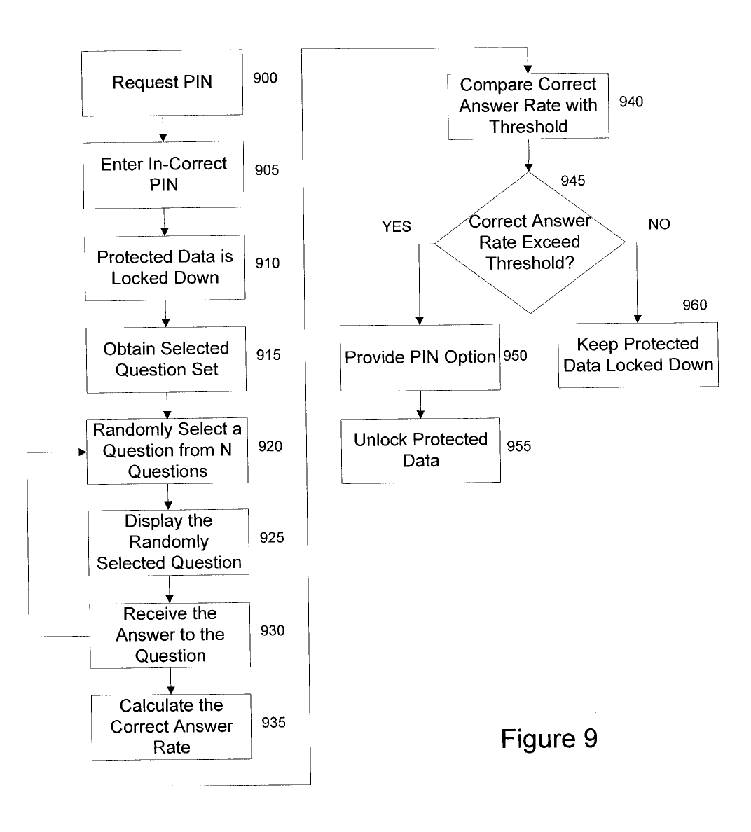

FIG. 9 illustrates a flow diagram for performing an access transaction according to one embodiment of the invention. In Block 900, a PIN is requested. In Block 905, an incorrect PIN is entered which fails to authenticate the identity of the user. In Block 910, the protected data is locked down which denies access to the protected data. In one embodiment, as illustrated in FIG. 8, the user may attempt to input an incorrect PIN X times prior to being locked out.

In Block 915, the question set which corresponds the questions corresponding to the user is obtained. In one embodiment, the question set is stored as a version code in the Block 535 (FIG. 5).

In Block 920, the local device randomly selects a particular question from the specific N questions which were selected by the user upon initialization. In one embodiment, the local device may randomly select the particular question. In another embodiment, the local device may select the particular question by a predetermined order.

In one embodiment, the local device retrieves the specific N questions from the remote device. In another embodiment, the local device already has the specific N questions locally stored.

In Block 925, the local device displays the particular question from the N specific questions from the Block 920.

In Block 930, the local device receives an answer to the particular question in response to the Block 925. The local device may continue selecting questions, displaying questions, and receiving questions as outlined in the Blocks 920, 925, and 930 until all or a portion of the specific N questions have been processed.

In Block 935, a correct answer rate is determined by comparing the stored answers to the questions with the recently received answers to the questions.

In Block 940, the correct answer rate from the Block 935 is compared with a predetermined threshold answer rate. In Block 945, if the correct answer rate exceeds the predetermined threshold, then the user is provided a PIN option.

In Block 950, the PIN option authenticates the identity of the user and authorizes the user to gain access to the local device. In one embodiment, the user is given the correct PIN. In this embodiment, the user may then gain access to the local device as an authorized user at a future time using the correct PIN. In another embodiment, the user is given an opportunity to reinitialize the local device with a new PIN.

In Block 955, the protected data is unlocked after the identity of the user is confirmed.

If the correct answer rate is less than the predetermined threshold, the identity of the user is not authenticated and access by the user is unauthorized. Accordingly, the protected data remains locked down and inaccessible in Block 960.

In the above examples, a PIN is utilized to gain access to the protected data. However, the PIN is shown as an exemplary primary authenticating information. Other forms of authenticating information may be utilized in substitution of the PIN.

The variables N, M, and X are utilized for illustrative purposes. Numerous values may be assigned to N, M, and X without departing from the scope of the invention.

The foregoing descriptions of specific embodiments of the invention have been presented for purposes of illustration and description.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A device comprising:
a. a pin module for locally storing a unique user identifier configured to correspond to an identity of an individual;
b. an answer module for locally storing an answer set wherein the answer set comprises an answer to a corresponding question and is configured to correspond to the identity of the individual; and
c. a controller for locally authenticating the identity of the individual by comparing an input with the answer set.

2. The device according to claim 1 wherein the unique user identifier is a personal identification number.

3. The device according to claim 1 wherein the unique user identifier includes a biometric reading.

4. The device according to claim 3 wherein the biometric reading is a fingerprint.

5. The device according to claim 3 wherein the biometric reading is an eye scan.

6. The device according to claim 3 wherein the biometric reading is a DNA sample.

7. The device according to claim 1 further comprising a question module configured to receive the corresponding question from a remote location.

8. The device according to claim 7 wherein the question module is configured to locally store the corresponding question.

9. The device according to claim 1 further comprising a non-protected storage module for locally storing non-protected data allowing access prior to confirming the identity of the individual.

10. The device according to claim 1 further comprising a protected storage module for locally storing protected data allowing access after the identity of the individual is confirmed.

11. A device comprising:
a. a primary authentication module comprising a pin module for locally storing a primary user identifier for authenticating an identity of a user;
b. a secondary authentication module comprising an answer module for locally storing a secondary user identifier for authenticating the identity of the user; and
c. a controller for selectively allowing access to protected data in response to one of the primary authentication module and the secondary authentication module.

12. The device according to claim 11 wherein the primary user identifier is a personal identification number.

13. The device according to claim 11 wherein the primary user identifier includes a biometric reading.

14. The device according to claim 13 wherein the biometric reading is a fingerprint.

15. The device according to claim 13 wherein the biometric reading is an eye scan.

16. The device according to claim 13 wherein the biometric reading is a DNA sample.

17. The device according to claim 11 wherein the secondary user identifier includes an answer to a question.

18. The device according to claim 17 wherein the secondary authentication module further comprises a question module configured to locally store the question.

19. The device according to claim 11 further comprising a non-protected storage module for locally storing non-protected data allowing access prior to confirming the identity of the user.

20. The device according to claim 11 further comprising a protected storage module for locally storing protected data allowing access after the identity of the individual is confirmed.

21. A method comprising:
a. requesting a primary user identifier;
b. receiving an incorrect primary user identifier;
c. requesting a secondary user identifier;
d. receiving a secondary user identifier response;
e. comparing the secondary user identifier response with the secondary user identifier stored within a local device; and
f. authenticating an identity of a user in response to comparing the secondary user identifier response with the secondary user identifier.

22. The method according to claim 21 further comprising displaying protected data in response to authenticating the identity of the user.

23. The method according to claim 21 wherein the primary user identifier is a personal identification number.

24. The method according to claim 21 wherein the secondary user identifier is an answer to a corresponding question.

25. The method according to claim 21 further comprising resetting the primary user identifier in response to authenticating the identity of the user.

26. The method according to claim 21 further comprising displaying the primary user identifier in response to authenticating the identity of the user.

27. A method of initializing a local device comprising:
a. uniquely identifying a user via a user identification;
b. storing a primary user identifier on the local device corresponding to the user;
c. storing a secondary user identifier on the local device corresponding to the user; and
d. authenticating an identity of the user through the secondary user identifier when the primary user identifier is not available.

28. The method according to claim 27 wherein the primary user identifier is a personal identification number.

29. The method according to claim 27 wherein the secondary user identifier is an answer to a corresponding question.

30. The method according to claim 27 further comprising requesting an answer from the user in response to a question wherein the answer is the secondary user identifier.

31. The method according to claim 30 further comprising receiving the question from a remote device.

33. A computer-readable medium having computer executable instructions for performing a method comprising:
a. requesting a primary user identifier;
b. receiving an incorrect primary user identifier;
c. requesting a secondary user identifier;
d. receiving a secondary user identifier response;
e. comparing the secondary user identifier response with the secondary user identifier stored within a local device; and
f. authenticating an identity of a user in response to comparing the secondary user identifier response with the secondary user identifier.
